(19) United States
(12) Patent Application Publication
(10) Pub. No.: US 2010/0332639 A1
(43) Pub. Date: Dec. 30, 2010

(54) Providing Manageability To An Electronic Device That Supports Location Limited Manageability Functionality

(76) Inventors: Osvaldo Diaz, San Mateo, CA (US); Mamoun Abu-Samaha, San Jose, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/866,933

(22) PCT Filed: Oct. 31, 2008
(86) PCT No.: PCT/US08/81934

§ 371 Date: Aug. 10, 2010

(30) Foreign Application Priority Data
Feb. 13, 2008 (US) 61028313
Feb. 13, 2008 (US) 61028319

(51) Int. Cl. G06F 15/173

(52) U.S. Cl. 709/223

(57) ABSTRACT

A request for a first function is detected 420. The first function is associated with a first device management protocol. A mapping 140 between a device location agnostic device management entity 110's functions and a device location limited device management entity 130's functions is accessed 430. The mapping 140 is used to translate 440 from the first function to a second function. The second function is associated with a device management protocol that is different from the first electronic device management protocol. The second function is used to provide 450 manageability to the electronic device 200B.

### RELATED APPLICATIONS

This patent application claims priority to and benefit of the co-pending U.S. Provisional Patent Application No. 61/028,319 which has an Attorney Docket Number 200801140-1. and is entitled “Remote Management with Translation Between OMA-DM and WSMAN” by Osvaldo Diaz et al., filed on Feb. 13, 2008.

This patent application claims priority to and benefit of the co-pending U.S. Provisional Patent Application No. 61/028,313 which has an Attorney Docket Number 200801143-1, and is entitled “Hosted Management Server Supporting Multiple Management Frameworks” by Osvaldo Diaz et al., filed on Feb. 13, 2008.

This Application is related to U.S. patent application, Ser. No. ______ by Osvaldo Diaz et al., filed on the same date as the present application and entitled “Managing Electronic Devices with Different Types of Device Location Limited Device Management Clients” with attorney docket no. HP 200801143-2, assigned to the assignee of the present application.

### BACKGROUND

Management can be provided to electronic devices by configuring the electronic devices and diagnosing problems associated with the electronic devices, among other things. An electronic device that uses a location limited client (“location limited” shall be used herein to refer to “device location limited management”) lose its management capabilities when the electronic device moves outside of an area that the electronic device is configured to use. A network that the electronic device is configured to use is an example of an area where the electronic device is provided manageability via the electronic device's location limited client communicating with a location limited server over the network. The network may be associated with a home, a small or medium sized-business, an enterprise, a company, or a carrier. An enterprise, company or carrier is typically supported by traditional information technology (IT) support capabilities. A home, a small business or a medium business are frequently not supported by traditional IT support capabilities.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a block diagram of a system for translating functions between a location agnostic device management entity and a location limited entity, according to one embodiment.

FIG. 2 is a block diagram of a system for translating functions between a location agnostic entity and a location limited entity, according to another embodiment.

FIG. 3 is a block diagram of an apparatus for providing manageability to an electronic device that supports location limited management functionality, according to one embodiment.

FIG. 4 depicts a flowchart describing a method for providing manageability to an electronic device that supports location limited manageability functionality, according to embodiments of the present invention.

FIG. 5 depicts a block diagram of one example of a type of computer that can be used in accordance with or to implement various embodiments which are discussed herein.

The drawings referred to in this description are not drawn to scale except if specifically noted.

### DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of various embodiments of the present invention, numerous specific details are set forth in order to provide a thorough understanding of the present invention. In other instances, well-known methods, procedures, components, and circuits have not been described in detail so as not to unnecessarily obscure aspects of the present invention.

Management can be provided to electronic devices by configuring the electronic devices and diagnosing problems associated with the electronic devices, among other things. An electronic device that uses a location limited client (“location limited” shall be used herein to refer to “device location limited management”) lose its management capabilities when the electronic device moves outside of an area that the electronic device is configured to use. A network that the electronic device is configured to use is an example of an area where the electronic device is provided manageability via the electronic device's location limited client communicating with a location limited server over the network.

Various embodiments pertain to providing manageability to an electronic device, which supports location limited manageability functionality, even when the electronic device moves outside of the area. For example, a location agnostic entity (“location agnostic” shall be used herein to refer to “device location agnostic device management”), which is capable of providing management regardless of where an electronic device is located, can be installed on the electronic device. The location agnostic entity and the location limited entity associated with the electronic device both provide a variety of functions. Function A provided by the location agnostic entity may provide similar management capabilities as function A′ associated with the location limited entity associated with the electronic device. Therefore, according to one embodiment, a mapping between a location agnostic entity's functions and the location limited entity's functions is used as a part of providing manageability even when the electronic device moves outside of an area, as will become more evident.

Conventionally, electronic devices that are behind a network address translation table (NAT) cannot communicate with an entity that provides management, which is on the other side of the network address translation table (NAT). However, various embodiments enable electronic devices behind a NAT to be managed by communicating with the managing entity that is on the other side of a NAT. In another example, a conventional electronic device may be managed only while it is associated with a certain network. The electronic device may or may not be behind a firewall. However, various embodiments enable electronic devices to be managed when the electronic device leaves the network. Various embodiments can also be used for electronic devices that have never been a part of a traditional IT network, such as a cell phone. Various embodiments can be used for devices that cross between a traditional IT enterprise environment and non-traditional IT enterprise environment. Various embodiments can be used for devices for small or medium sized businesses (SMBs) that do not have traditional IT support capabilities. Therefore, various embodiments are well suited to home devices, which may be behind a NAT or a firewall, or a combination thereof, or a work device, which may be behind a firewall, among other things.

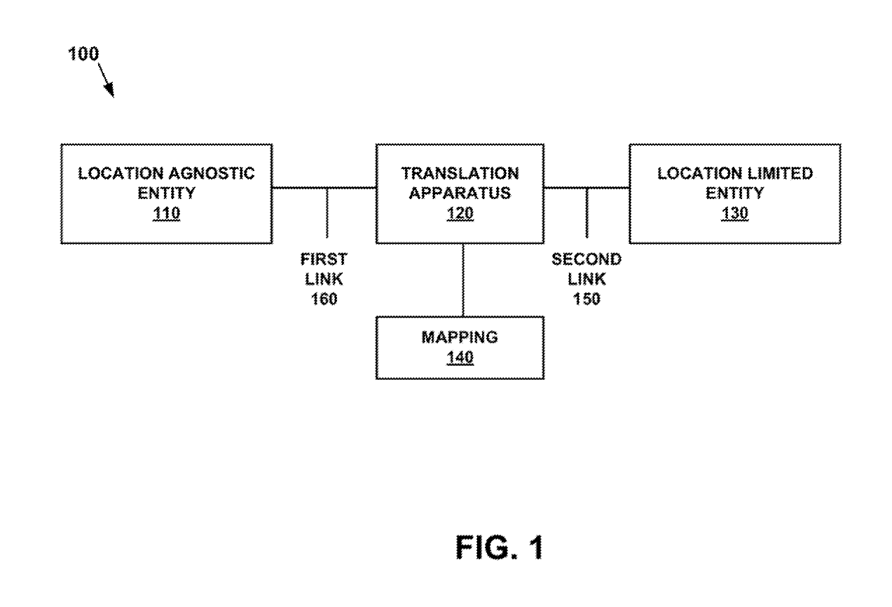

FIG. 1 is a block diagram of a system 100 for translating functions between a location agnostic device management entity (also known as “location agnostic entity”) and a location limited device management entity (also known as “location limited entity”), according to one embodiment. The blocks that represent features in FIG. 1 can be arranged differently than as illustrated, and can implement additional or fewer features than what are described herein. Further, the features represented by the blocks in FIG. 1 can be combined in various ways. The system 100 can be implemented using software, hardware, firmware, or a combination thereof.

The system 100 includes a location agnostic entity 110, a location limited entity 130, a mapping 140 between functions associated with the two entities 110 and 130, and a translation apparatus 120 for translating functions between the two entities 110 and 130.

The entities 110, 130 may be either clients or servers. Either the first link 160 or the second link 150, or both of the links 160, 150 may be a communications link over a network or may be a communications link that resides in an electronic device. The first link 160, or the second link 150 or both of the links 160, 150 may have Wi Fi capabilities.

The apparatus 120 can be co-located with the location agnostic entity 110. For example, the apparatus 120 and the location agnostic entity 110 may reside on the same server or on a network operations center (NOC), among other things. The location agncstic entity 110 and the apparatus 120 may both be associated with a data center for an IT enterprise or reside with a web server.

The apparatus 120 may be co-located with the location limited entity 130. For example, the apparatus 120 and the location limited entity 130 may reside on an electronic client device.

The apparatus 120, the location agnostic entity 110, and the location limited entity 130 may all reside on the same electronic device, may be associated with the same company, or may be associated the same traditional IT enterprise. The electronic device may be a client device or a server device. The server device may be a web server.

The apparatus 120 may be located separately from both the location agnostic entity 110 and the location limited entity 130. For example, the apparatus 120 may be located on an electronic device, such as a server device, that is separate from the electronic devices that the location agnostic entity 110 and the location limited entity 130 reside on. In one embodiment, the location agnostic entity 110, or the apparatus 120, or a combination thereof, reside on a web server. The mapping 140 may be co-located with the translation apparatus 120 or may be located separately from the translation apparatus 120.

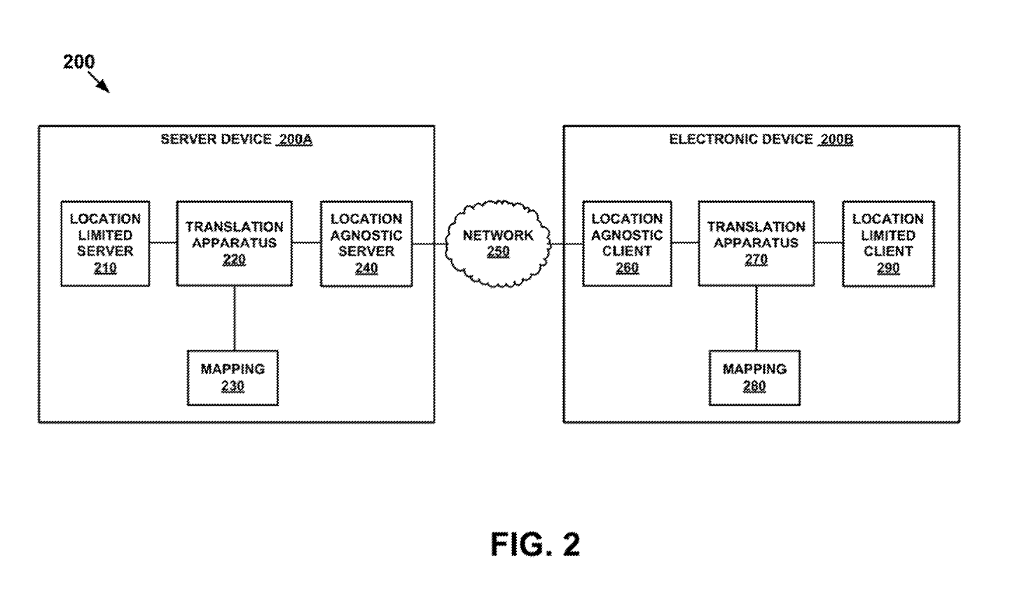

FIG. 2 is a block diagram of a system 200 for translating functions between a location agnostic entity and a location limited entity, according to another embodiment. The blocks that represent features in FIG. 2 can be arranged differently than as illustrated, and can implement additional or fewer features than what are described herein. Further, the features represented by the blocks in FIG. 2 can be combined in various ways. The system 200 can be implemented using software, hardware, firmware, or a combination thereof.

As depicted in FIG. 2, the translation can occur between two servers 210, 240 and between two clients 260, 290. For example, the first translation apparatus 220 and its corresponding mapping 230 can translate functions between a location limited server 210 and a location agnostic server 240. The second translation apparatus 270 and its corresponding mapping 280 can translate functions between a location agnostic client 260 and a location limited client 290.

The location limited server 210 and the location limited client 290 are examples of location limited entities 130. The location agnostic server 240 and the location agnostic client 260 are examples of location agnostic entities 110.

Although the server device 200A, as depicted in FIG. 2, includes the servers 210, 240, the translation apparatus 220, and the mapping 230, the server device 200A may include only one or may include more than one of the servers 210, 240, the first translation apparatus 220, or the first mapping 230. The server device 200A may be associated with a service provider. Any one or more of, the servers 210, 240, the first translation apparatus 220, or the first mapping 230 can reside at, among other things, a network operations center, an enterprise, or a server device 200A. The server device 200A may be a web server.

Although the client device 200B, as depicted in FIG. 2, includes the clients 260, 290, the translation apparatus 270 and the mapping 280, the client device 200B may include only one or may include more than one of the clients 260, 290, the second translation apparatus 270, and the second mapping 280. The electronic device 200B may be, among other things, a mobile device, an appliance, a router, a model, a television, or a computer.

Communications between various entities depicted in FIG. 2 may be performed over an Internet. For example, the network 250 may be the Internet. Communications between the location agnostic server 240 and the location agnostic client 260 depicted in FIG. 2 may be performed over a network 250 that includes Wireless Fidelity (Wi Fi) capabilities. Although network 250 is the only network depicted in FIG. 2, according to various embodiments, a network may be used to communicate between any of the components 210, 220, 230, 240, 260, 270, 280, 290 depicted in FIG. 2.

An electronic device 200B may be a mobile device such as a cell phone, a laptop, or a personal digital assistant (PDA), among other things. An electronic device may be a device that is used in a home (also referred to herein as a “home device”), such as a router, a gateway, a modem, a kitchen appliance, a television, a set-top-box, a computer, a printer, and a laptop, among other things. An electronic device 200B may be a device that is used for work (also referred to herein as “work devices”), such as a router, a modem, a gateway, a computer, a laptop, a phone, a PDA, and a printer, among other things. Work devices may be associated with a company or an enterprise that traditionally provides information technology. A company may be a small, medium or large-sized company. An electronic device 200B may be a computer based device, such as a desk top computer, a laptop, or a server device, among other things. An electronic device may be a client device 200B or a server device 200A.

As will become more evident, management can be provided to electronic devices 200B by configuring the electronic devices 200B and diagnosing problems associated with the electronic devices, among other things. For example, an electronic device 200B can be managed by updating an application or diagnosing an error. In a second example, several electronic devices 200B, such as a television, a personal computer for work, and a laptop may all be connected to a router in a home. The router would use a NAT to provide connectivity for the three devices. The NAT would translate a single real IP address into three pseudo IP addresses for the three devices. Traditionally this has made it very difficult to manage devices 200B that are behind a NAT. Further, many of these devices 200B would have location limited functionality. However, according to various embodiments, a location agnostic protocol can be used to provide manageability to these devices 200B even though they are behind a NAT by communicating with cell phone towers and the Internet.

In another example, a person that works for company X may take their laptop 200B that is configured for company X's network, that is behind a firewall X′, to another company Y that has a network behind firewall Y′. Traditionally, one or more firewalls, such as firewall X′ and Y′, would prevent the person from using their laptop 200B while inside of company Y. However, according to various embodiments, a location agnostic protocol and one or more translation apparatuses 120, 220, 270 and corresponding mappings 140, 230, 280 can enable the laptop 200B to communicate around the firewalls.

In yet another example, a person buys a laptop, a handset phone, or a mobile device from a company that sells electronic devices 200B. Assume that this company is not a traditional IT enterprise but is interested in providing manageability to the devices 200B that they sell. According to various embodiments, the electronic devices 200B they sell may have clients 260 and 290 and a second translation apparatus 270 as depicted in FIG. 2. The company may have servers 210 and 240 and a first translation apparatus 220 as depicted in FIG. 2 to provide the manageability to the electronic devices 200B that the company sells.

In still another example, assume that the electronic device 200B is lost and the user of the electronic device 200B calls up customer services or goes to a self care portal associated with a location agnostic server 240, such as an OMA-DM server, and requests that the hard disk on the electronic device 200B be reformatted or that the electronic device 200B be locked up. The location agnostic server 240 can communicate with the location agnostic client 260 on the electronic device 200b to reform that electronic device 200B's hard disk or to lock the electronic device 200B. Customer care may interact with a user interface associated with the location agnostic server 240 as a part of reformatting the electronic device 200B's hard disk or locking the electronic device 200B.

Other examples where various embodiments may be used include, but are not limited to, different phones with different protocols, different carriers, small or medium businesses that do not have traditional IT infrastructure, changing chip sets in a computer 200B where the original chip set and the new chip set use different protocols for providing manageability, a lost electronic device 200B, locking an electronic device 200B, reformatting hard disk on an electronic device 200B, shredding a hard disk on an electronic device 200B, recovering data, determining what OS was running on a device 200B, which has a crashed disk configuration.

Various embodiments pertain to providing management to an electronic device 200B that has a location limited client 290 by mapping the location limited client 290's functions to a location agnostic client 260's functions or vice versa. Various management platforms and management protocols (also referred to herein as “device management protocols”) can be used as a part of providing management to the electronic device 200B.

A management platform defines a standard that software, associated with an entity 110, 130, 210, 240, 260, 290, can be developed around, according to one embodiment. One entity is typically a managing entity that manages another entity (also referred to as “a managed entity”) and by extension manages the device that a managed entity resides on: Entities 210, 240 are examples of managing entities. Entities 260, 290 are examples of managed entities. Entities 110 and 130 may be either managing entities or managed entities, as described herein. Electronic device 200B is an example of a managed device that one or more managed entities 260, 290 reside on. Entities 110, 130, 210, 240, 260, 290 that conform to related management platforms can communicate with each other 110, 130, 210, 240, 260, 290 using a corresponding management protocol.

Examples of management platforms that have corresponding management protocols are Open Mobile Alliance Device Management (OMA-DM), Web Services Management (WSMAN), Simple Network Management Protocol (SNMP), Technical Requirement-069 (TR-069), and TR-111. The entities 110, 130, 210, 240, 260, 290 typically use a communication protocol, such as TCP-IP, to transmit information that conforms to the respective management protocol to enable a managing entity 210, 240 to manage a managed entity 260, 290. As will become more evident, management platforms and their respective management protocols can be either location agnostic or location limited.

Location agnostic device management pertains to managing devices 200B regardless of where the devices 200B are located. A location agnostic protocol is a management protocol that can be used for communicating with entities 110, 260 that reside on devices 200B regardless of where the devices 200B are located. The location agnostic protocol, according to one embodiment, is a HyperText Transfer Protocol (HTTP) Extensible Markup Language (XML) based protocol that can be used, for example, by phones. The location agnostic protocol (also referred to herein as a “device location agnostic device management protocol”) may enable part of the communications to be transmitted over the Internet and may use short message service (SMS), for example, to initiate communications. A location agnostic protocol can be used, for example, to communicate via one or more cell phone towers and the Internet. An example of a location agnostic protocol is the OMA-DM protocol.

Since a location agnostic protocol can be used to communicate via one or more cell phone towers and the Internet, a location agnostic protocol can be used to communicate with electronic devices 200B regardless of where they are located. For example, a location agnostic protocol can be used to communicate with an electronic device 200B even when that electronic device 200B moves. In another example, a location agnostic protocol can be used to communicate with an electronic device 200B that is behind a NAT, or behind a firewall.

A location agnostic entity 110 may be a client 260 or a server 240, among other things, which conforms to a location agnostic management platform, such as OMA-DM.

Location limited device management pertains to managing devices 200B but restricts where those devices 200B are located. That is, location limited device management can only be used to manage devices 200B while the devices 200B are in a particular physical or electronic (network) location. For example, the devices 200B may be restricted to a network associated with an enterprise or a home. A location limited protocol (also referred to herein as a “device location limited device management protocol”) is a management protocol that can be used for communicating with entities 110, 290 that reside on devices 200B while those devices 200B are associated with a particular area or a particular network. Examples of location limited protocols are Web Services Management (WSMAN), Simple Network Management Protocol (SNMP), Technical Requirement-069 (TR-069), and TR-111.

Many electronic devices 200B are traditionally configured to communicate using location limited protocols. For example, many computer based devices are configured to use the WSMAN protocol. In another example, many chip sets are configured to use the WSMAN protocol. In another example, many televisions are configured to use TR-111. In another example, many routers and modems are configured to use TR-069.

A location limited entity 130 may be a client 290 or a server 210, among other things, which conforms to a location limited management platform, such as WSMAN, SNMP, TR-069, or TR-111. A location limited entity 130 may reside on an electronic device 200A, 200B that is a mobile device, a television, a computer based device, or a router, among other things.

Various embodiments provide a mapping 140, 230, 280 between a device location agnostic entity 110, 240, 260's functions and a device location limited entity 130, 210, 290's functions. According to one embodiment, the device location agnostic entity 110, 240, 260's functions are represented by OMA-DM objects (also known as “managed objects”). For example, a mapping 280 associated with an electronic client device 200B may map managed objects (MOs) to device location limited functions, such as WSMAN functions.

The mapping 140, 230, 280 may map a subset of the functions associated with a device location limited entity 130, 210, 290 and a device location agnostic entity 110, 240, 260. The determination may be made by analyzing what functions are used most often or what functions would provide the greatest business opportunity.

In one embodiment, a translation apparatus 120 and a corresponding mapping 140 may be implemented as a proxy client, which resides, for example, on a Network Operations Center (NOC) server. For example, assume that the location agnostic entity 110, such as an Open Mobile Alliance Device Management (OMA-DM) server, is associated with a service provider's server device, the translation apparatus 120 and corresponding mapping 140 are associated with a proxy client on the NOC server, and the location limited entity 130, such as a WSMAN client, is associated with a user's electronic device. Also assume that the user's electronic device includes a minimal location agnostic client, such as a minimal OMA-DM client. The NOC server with the associated proxy client and the location agnostic entity 110 may be associated with the same data center. The NOC server with the associated proxy client and the WSMAN location limited entity 130 may be associated with the same data center.

A help desk or a user self care web page may communicate with the location agnostic entity 110 which in turn communicates with the proxy client. The proxy client can use the translation apparatus 120 and the mapping 140 to determine a location agnostic function. A data structure representing the determined function can be communicated, using the OMA DM protocol, to the user's electronic device. The electronic device can use the minimal OMA-DM client to extract the data structure and communicate the pertinent information to the location limited entity 130.

As stated in the above example, the electronic client can use a minimal location agnostic client, such as a minimal OMA-DM client. For example, if a location agnostic management platform and corresponding protocol provide interfaces for functions A, B and C but function A will suffice, the minimal location agnostic client may support function A but not support functions B and C.

According to one embodiment, the OMA DM protocol is used to communicate, for example, over the second link 150 as depicted in FIG. 1 or to communicate, for example, over the network 250 as depicted in FIG. 2. According to one embodiment, the OMA DM protocol is modified so that electronic devices that include a location limited entity 130 or a location limited client 290, among other things, are always connected and therefore Short Message Services (SMSs) are not required.

According to one embodiment, what is commonly known as “push technology” is used as a part of various client or server entities communicating. For example, “push technology” may be used to communicate between a translation apparatus 120 and a location agnostic entity 110 or between a translation apparatus 120 and a location limited entity 130. In another example, “push technology” may be used to provide communications between a location agnostic server 240 and a location agnostic client 260 or vice versa.

“HTTP server push” is one subcategory of “push technology.” According to one embodiment, HTTP server push is used as a part of communicating, for example, between a server 200A and a client 200B. HTTP server push typically involves a server 200A pushing information to a client 200B. In situations where a client 200B is pushing information to a server 200A, the client 200B may employ a push technology that is similar to HTTP server push.

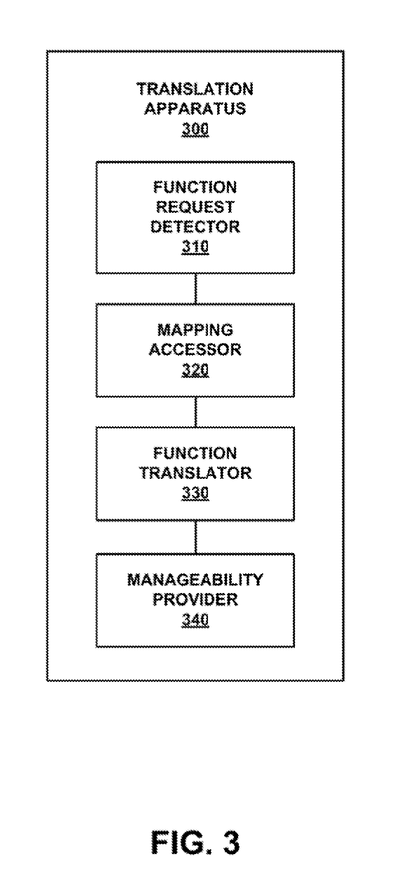

FIG. 3 is a block diagram of an apparatus for providing manageability to an electronic device that supports location limited management functionality, according to one embodiment. The blocks that represent features in FIG. 3 can be arranged differently than as illustrated, and can implement additional or fewer features than what are described herein. Further, the features represented by the blocks in FIG. 3 can be combined in various ways. The system 300 can be implemented using software, hardware, firmware, or a combination thereof.

The translation apparatus 300, as depicted in FIG. 3, includes a function-request-detector 310, a mapping-between-electronic device-location-agnostic-functions-and-electronic device-location-limited-functions-accessor 320 (also referred to as a “mapping-accessor”), a translator-between-device-location-agnostic-functions-and-device-location-limited-functions 330 (also referred to as a “function-translator”), and a manageability-provider 340.

The function-request-detector 310 is configured for detecting a request for a first function. The mapping-accessor 320 is configured for accessing a mapping 140, 230, 280 between a device location agnostic entity 110, 240, 260's functions and device location limited entity 130, 210, 290's functions. The device location agnostic entity 110, 240, 260's functions are associated with a location agnostic protocol that is used for communicating with electronic devices 200B regardless of where those electronic devices 200B are located. The device location limited entity 130, 210, 290's functions are associated with a device location limited protocol that is not used for communicating with electronic devices 200B regardless of where those electronic devices 200B are located. The function-translator 330 is configured for translating the first function to a second function based on the mapping 140, 230, 280. The manageability-provider 340 is configured for providing manageability to the electronic device 200B based on the second function. Apparatuses 120, 220, 270 are examples of an apparatus 300.

Although FIGS. 1 and 2 depicted mappings 140, 230, 280 between one type of location agnostic entity 110, 240, 260 and one type of location limited entity 130, 210, 290, various embodiments can be used for mapping between, for example, one type of location agnostic device management entity and multiple types of location limited device management entities. For example, there may be one translation apparatus and corresponding mapping for translating between OMA-DM and WSMAN, a second translation apparatus and corresponding mapping for translating between OMA-DM and TR-069, and a third translation apparatus and corresponding mapping for translating between OMA-DM and SNMP. These three translation apparatuses and their corresponding mappings could be associated with, for example, a server 200A for a company or an enterprise that provides manageability to various types of electronic devices 200B, such as home devices, work devices, and mobile devices, among other things. Specialists that work at the company or enterprise could use the server 200A to provide manageability to the electronic devices 200B.

According to one embodiment, multiple electronic devices 200B can be controlled by the same administrative and operations domain that, for example, a location limited server 210, a translation apparatus 220, a mapping 230, and a location agnostic server 240 are associated with. In a specific example, a virtualized architecture for a wholesale service may offer multiple service providers. In a specific example, Amazon EC3/S2™ could implement a location limited server 210, a translation apparatus 220, mapping 230, and location agnostic server 240 using their virtual server technology to support multiple electronic devices 200B with different location agnostic clients 260, translation apparatuses 270, mappings 280, and location limited clients 290. The electronic devices 200B may use different types of location agnostic clients 260, translation apparatuses 270, mappings 290, and location limited clients 290. For example, one electronic device 200B may use a WSMAN location limited client 290 while another electronic device 200B uses a TR-069 location limited client 290.

There are various ways to interface with a device location agnostic entity 110, 240, 260 or a device location limited entity 130, 210, 290. A program, such as an application, may transmit a request to either a location agnostic entity or location limited entity. For example, a server device 200A or a client device 200B may detect that an application on the client device 200B needs to be updated and may communicate with the appropriate entities 110, 130, 260, 290, 210, 240 to get the application updated. In another example, a diagnostic function may detect that a problem has occurred on a client device 200B and communicate for example with a location limited client 290 that resides on the client device 200B. In a third example, a user of an electronic device 200B may interact with a web page to request that something be performed. The web server for that web page may communicate, for example, with a location agnostic server 240. The translation apparatus 220 may perform a translation. Communications may proceed to the location limited server 210 to provide the requested service. In a fourth example, a user may interact with their electronic device 200B to request a service. A location limited client 290 on the user's electronic device 200B may be invoked. The translation apparatus 270 may translate the location limited client 290's function to the location agnostic client 260's function. Communications may proceed to a location agnostic server 240 which provides services based on the determined function. In yet another example, commands or scripts may be used to interface with entities 110, 130, 210, 240, 260, 290.

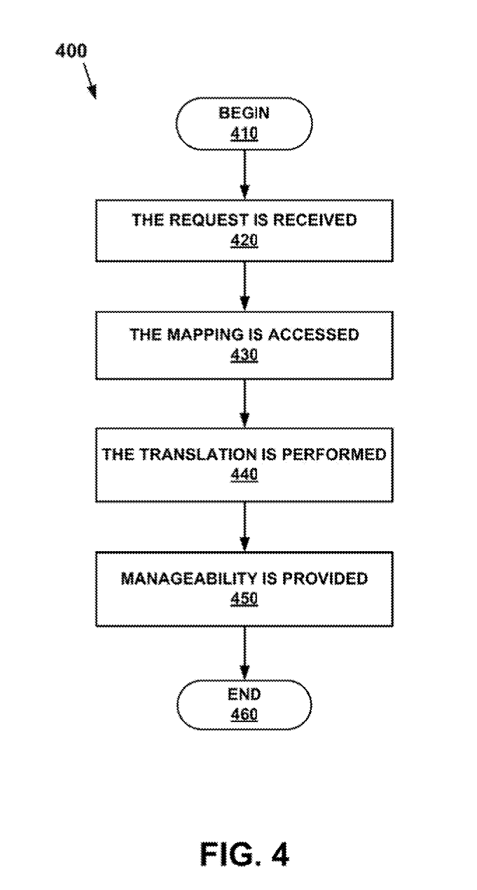

FIG. 4 depicts a flowchart 400 describing a method for providing manageability to an electronic device that supports location limited manageability functionality, according to embodiments of the present invention. Although specific steps are disclosed in flowchart 400, such steps are exemplary. That is, embodiments of the present invention are well suited to performing various other steps or variations of the steps recited in flowchart 400. It is appreciated that the steps in flowchart 400 may be performed in an order different than presented, and that not all of the steps in flowchart 400 may be performed.

The first illustration shall refer to FIG. 1. Assume for the first illustration that the location agnostic entity 110 is an OMA-DM server associated with an Enterprise, that the translation apparatus 120 and mapping 140 are also associated with the same enterprise and the location limited entity 130 is a WSMAN client associated with a laptop. Assume that the communications link 150 between the translation apparatus 120 and the laptop is the Internet.

Assume that the user of the laptop has requested that a particular application on the laptop be automatically updated when software updates for the application become available. Assume that a new software update has just become available and a request to update the laptop is generated. In response to the new software update becoming available, the OMA-DM server 110 generates an OMA-DM request to update the application and transmits the OMA-DM request to the translation apparatus 120.

At 410, the method starts.

At 420, the request is received. For example, the function request detector 310, associated with the translation apparatus 120, receives the OMA-DM request to update the application. “Update the application” is an example of a first function and the OMA-DM request to update the application is an example of a request for a first function. The OMA-DM protocol is an example of a first device management protocol, which is a location agnostic protocol.

At 430, the mapping is accessed. For example, the mapping accessor 320, associated with the translation apparatus 120, accesses the mapping to determine what WSMAN function corresponds to the OMA-DM request to update the application. An OMA-DM server 110 is an example of a location agnostic entity 110. A WSMAN client 130 is an example of a location limited entity 130. WSMAN is an example of a second device management protocol, which is a location limited protocol.

At 440, a translation is performed. For example, the function translator 330, associated with the translation apparatus 120, translates the OMA-DM update the application function into the WSMAN update the application function based on the mapping 140. WSMAN is an example of a second device management protocol that is different than the first device management protocol.

At 450, manageability is provided. For example, the manageability provider 340, associated with the translation apparatus 120, can use the OMA-DM protocol to communicate the WSMAN update the application function, according to one embodiment, across the Internet associated with the second link 150 to the laptop. For example, the OMA-DM protocol may be used to communicate a data structure that describes the WSMAN update the application function to a cell phone tower, for example, and over the Internet to the laptop. A minimal OMA-DM client associated with the laptop may extract the data structure and communicate the data structure to the WSMAN client 130 that resides on the laptop, which uses the data structure to provide the WSMAN update the application function.

At 460, the method ends.

The second illustration shall refer to FIG. 2. Assume for the second illustration that the location limited server 210 is a WSMAN server, the location agnostic server 240 is an OMA-DM server, the location agnostic client 260 is an OMA-DM client, and the location limited client 290 is a WSMAN client.

Also assume that the WSMAN server, the first translation apparatus 220 and corresponding mapping 230, and the OMA-DM server 240 reside on a web server for a company that provides software updates. Assume that the OMA-DM client 260, the second translation apparatus 270 and corresponding mapping 280, and the location limited client 290 reside at an electronic client device 200B.

A WSMAN server 210 generates a WSMAN request to update the application and transmits the WSMAN request to the first translation apparatus 220.

At 410, the method begins.

At 420, the request is received. For example, the function request detector 310, associated with the first translation apparatus 220, receives the WSMAN request to update the application. “Update the application” is an example of a first function that is associated with a first device management protocol, which in this case is the WSMAN protocol. The WSMAN protocol is an example of a first protocol.

At 430, the mapping is accessed. For example, the mapping accessor 310, associated with the first translation apparatus 220, accesses the corresponding mapping 230 to determine what OMA-DM function corresponds to the WSMAN request to update the application. An OMA DM server 240 is an example of a location agnostic entity 110. A WSMAN server 240 is an example of a location limited entity 130. The OMA-DM protocol is an example of a location limited protocol. The mapping 230 is an example of a first mapping.

At 440, a translation is performed. For example, the function translator 330, associated with the first translation apparatus 220, translates the WSMAN update the application function, a first function, into an OMA-DM update the application function, a second function, based on the first mapping 230. The OMA-DM update the application function is associated with the OMA-DM protocol which is different from the WSMAN protocol.

At 450, manageability is provided. For example, the manageability provider 340, associated with the first translation apparatus 220, transmits the OMA-DM update the application function, which was determined in the previous step, to the OMA-DM server 240.

At 460, the method ends.

The OMA-DM server 240 transmits the OMA-DM update the application function determined in process 440 to the laptop, over a network 250, which in this illustration includes via one or more cell phone towers and the Internet, using the OMA-DM protocol. A packet describing the OMA-DM update the application function may be transmitted using a protocol, such as TCP-IP, over the network 250. The OMA-DM client 260 on the laptop 200B receives the OMA-DM update the application function and transmits the OMA-DM update the application function to the second translation apparatus 270, which also resides on the laptop 200B.

At 410, the method begins again.

At 420, the request is received. For example, the function request detector 310, associated with the second translation apparatus 270, receives the OMA-DM update the application function. The OMA-DM update the application function is an example of a second function.

At 430, the mapping is accessed. For example, the mapping accessor 320, associated with the second translation apparatus 270, accesses the mapping 280 to determine what WSMAN function corresponds to the OMA-DM update the application function. The mapping 280 is an example of a second mapping. An OMA DM client 260 on the laptop 2006 is an example of a device location agnostic entity 110. A WSMAN client 290 on the laptop 200B is an example of a location limited entity 130.

At 440, the translation is performed. For example, the function translator 330, associated with the second translation apparatus 270, translates the OMA-DM update the application function, a second function, into a WSMAN update the application function, a third function, based on the second mapping 280.

At 450, manageability is provided. For example, the manageability provider 340, associated with the second translation apparatus 270, uses the WSMAN update the application function, which was determined in the previous step, to update the application, thus providing manageability to the laptop 200B.

At 460, the method ends.

In a third and fourth illustration, the communications could move in the other direction. For example, in a third illustration, assume that a software error or a hardware error is encountered on a desktop computer that includes either a location limited entity 130 as depicted in FIG. 1. Assume that the error does not render the desktop inoperable. In this case, the request for a function, such as a request for diagnosing the software or hardware error, could originate on the desktop computer and be communicated to, for example, a server that executes the translation apparatus 120 and the location agnostic entity 110.

In a fourth illustration, assume that a hardware error is encountered on an electronic device 200B, that is television or a printer, that includes the clients 260 and 290, second translation apparatus 270, and second mapping 280 as depicted in FIG. 2. Again assume that the error does not render the television or the printer inoperable. In this case, the request for a function, such as a request for diagnosing the error, could originate on the television or the printer and be communicated to, for example, a service provider that executes the servers 210, 240 and the first translation apparatus 220.

In a fifth illustration, various embodiments can be used to limit the functionality of an electronic device 200B. For example, a parent may want to limit what types of content can be viewed on an electronic device 200B that is a television. According to various embodiments, the parent may interact with their television 200B using for example their remote to navigate menus on the television 200B or may interact with a web page to request that the types of content be limited. The request can be communicated to device location agnostic server 240 associated with a server device 200A to configure the television 200B and then to a device location limited client 290 on the television 200B using various embodiments described herein.

In a sixth illustration, various embodiments may be used to enable a parent to perform “parental control” to an electronic device 200B, that is child's personal computer, via a web page on another personal computer that is either in the home or at work.

Various embodiments provide high scalability in contrast to a virtual private network (VPN). For example a VPN could be used to communicate with approximately 100,000 electronic devices whereas a location agnostic protocol in combination with various embodiments could be used for communicating with approximately 20-30 million electronic devices.

According to one embodiment, an electronic device 200B may initially include a location limited client 290 (FIG. 2) but not include a location agnostic client 260 (FIG. 2). According to one embodiment, the location agnostic client 260 can be installed on the converged electronic device 200B, as will become more evident. Various embodiments described herein can also be used to install a translation apparatus 270 and a corresponding mapping 280 in addition to installing the location agnostic client 260 on the electronic device 200B, as will become more evident.

For example, since there are many different types of electronic devices 200B (FIG. 2) with many different types of communications protocols and management platforms as well as electronic devices that lack management platforms, there is a need for a method and a system to communicate and manage these disparate electronic devices, for example, with one management model. Further, there is a need for managing these disparate electronic devices from a single user interface.

Assume for the sake of illustration, assume that server 240A (FIG. 2) is a multi-management capable server and that electronic devices B and C are different types of electronic devices 200B that the multi-management capable server 200A communicates with. An apparatus, which receives the device capabilities of the various electronic devices B and C, can be associated with the server 200A. The apparatus uses the devices B's and C's device capabilities to determine which management protocol each of the electronic devices B and C use. The determined management protocols are used to install a location agnostic client onto the electronic devices B and C. For example, if the electronic device B's device capabilities indicate that electronic device B uses the Web Services Management (WSMAN) protocol, then the WSMAN protocol is used to install a location agnostic client 260, such as an Open Mobile Alliance Device Management (OMA DM) client, onto electronic device B. If another electronic device C's device capabilities indicate that electronic device C uses Technical Requirement-069 (TR-069) protocol, then the TR-069 protocol is used to install a location agnostic client 260, such as OMA DM client, onto electronic device C. The location agnostic clients that are installed on the electronic devices B and C can be used to communicate with location agnostic server, such as location agnostic server 240, to provide management to both of the electronic devices B and C.

Different electronic devices B and C have different capabilities. Information describing an electronic device B, C's capabilities can be used to determine the protocol that an electronic device B, C is configured to use. For example, information describing a device B, C's capabilities can be used to determine that the electronic device B or C has the ability to communicate using WSMAN or TR-069, for example.

The device capabilities may be requested or provided without being requested. For example, when an electronic device B, C is turned on, it performs a process called “boot strapping” during which the electronic device B, C is provisioned. While boot strapping, the electronic device B, C may communicate with a server 200A that can either request the electronic device B or C's capabilities or the electronic device B, C may provide its capabilities without the server 200A requesting the capabilities.

According to one embodiment, registration information for an electronic device B, C can be used by a server 200A to determine the management protocol that an electronic device B, C is configured to use. The registration information may be provided to any entity that provides an apparatus for managing electronic devices with different types of location limited clients, according to various embodiments. In a specific example, the registration information may be provided by a company that sells electronic devices to, for example, a company that is a traditional IT enterprise that a management server is associated with.

According to one embodiment, information describing device capabilities can be determined based on management policies that reside for example with a management server, a service provider, the electronic device B, C in question, or at another electronic device associated with the same environment, such as a home or business premises, that the electronic device B, C in question is associated with.

According to one embodiment, information describing device capabilities can be used for reinstalling a management client, such as a location limited client or a location agnostic client, for example, if a managed client is corrupted or disappears.

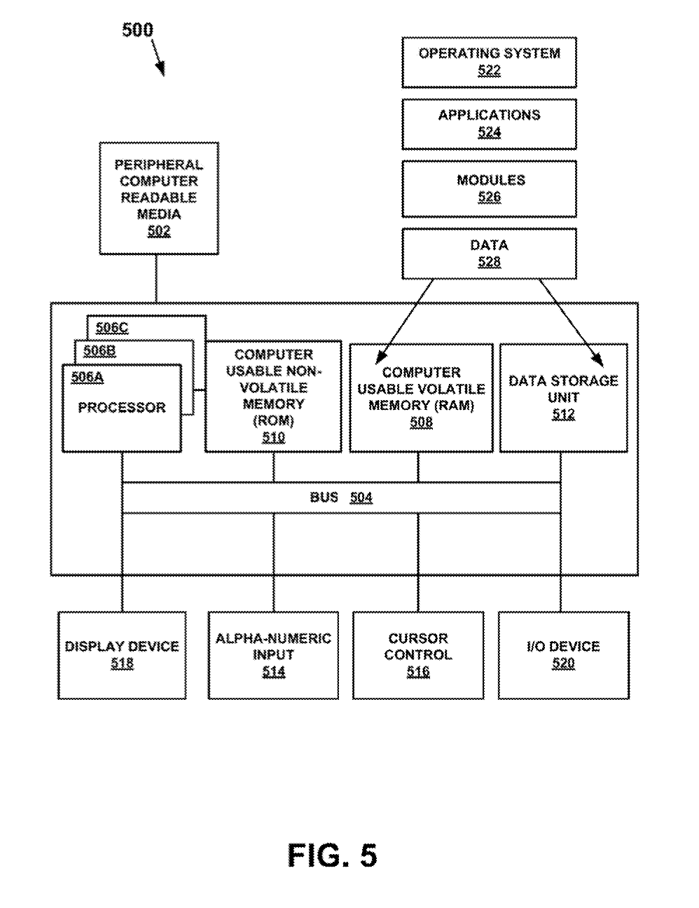

FIG. 5 depicts a block diagram of one example of a type of computer (computer system 500) that can be used in accordance with or to implement various embodiments which are discussed herein. It is appreciated that computer system 500 of FIG. 5 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, media centers, handheld computer systems, multi-media devices, and the like. As shown in FIG. 5, computer system 500 of FIG. 5 is well adapted to having peripheral computer-readable media 502 such as, for example, a floppy disk, a compact disc, and the like coupled thereto.

System 500 of FIG. 5 includes an address/data bus 504 for communicating information, and a processor 506A coupled to bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 5066, and 506C may be any of various types of microprocessors. System 500 also includes data storage features such as a computer usable volatile memory 508, e.g. random access memory (RAM), coupled to bus 504 for storing information and instructions for processors 506A, 506B, and 506C. System 500 also includes computer usable non-volatile memory 510, e.g. read only memory (ROM), coupled to bus 504 for storing static information and instructions for processors 506A, 5066, and 506C. Also present in system 500 is a data storage unit 512 (e.g., a magnetic or optical disk and disk drive) coupled to bus 504 for storing information and instructions. System 500 also includes an optional alphanumeric input device 514 including alphanumeric and function keys coupled to bus 504 for communicating information and command selections to processor 506A or processors 506A, 506B, and 506C. System 500 also includes an optional cursor control device 516 coupled to bus 504 for communicating user input information and command selections to processor 506A or processors 506A, 506B, and 506C. In one embodiment, system 500 also includes an optional display device 518 coupled to bus 504 for displaying information.

Referring still to FIG. 5, optional display device 518 of FIG. 5 may be a liquid crystal device, cathode ray tube, plasma display device or other display device suitable for creating graphic images and alphanumeric characters recognizable to a user. Optional cursor control device 516 allows the computer user to dynamically signal the movement of a visible symbol (cursor) on a display screen of display device 518 and indicate user selections of selectable items displayed on display device 518. Many implementations of cursor control device 516 are known in the art including a trackball, mouse, touch pad, joystick or special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands. System 500 is also well suited to having a cursor directed by other means such as, for example, voice commands. System 500 also includes an I/O device 520 for coupling system 500 with external entities. For example, in one embodiment, I/O device 520 is a modem for enabling wired or wireless communications between system 500 and an external network such as, but not limited to, the Internet.

Referring still to FIG. 5, various other components are depicted for system 500. Specifically, when present, an operating system 522, applications 524, modules 526, and data 528 are shown as typically residing in one or some combination of computer usable volatile memory 508, (e.g., RAM), computer usable non-volatile memory 510 (e.g., ROM), and data storage unit 512. In some embodiments, all or portions of various embodiments described herein are stored, for example, as an application 524 and/or module 526 in memory locations within RAM 508, computer-readable media within data storage unit 512, peripheral computer-readable media 502, and/or other tangible computer readable media.

For example, any one or more of 110, 120, 130, 140 (FIG. 1), 210, 220, 240, 260, 270, 290 (FIG. 2), 300 (FIG. 3), and instructions implementing the flowchart 400 (FIG. 4) may be associated with a computer 500. Any one or more of 110, 120, 130, 140 (FIG. 1), 210, 220, 240, 260, 270, 290 (FIG. 2), 300 (FIG. 3), and instructions implementing the flowchart 400 (FIG. 4) may be associated with the same computer 500 or with different computers 500. According to one embodiment, the server device 200A and the electronic device 200B are computers 500. Any one or more of 110, 120, 130, 140 (FIG. 1), 210, 220, 240, 260, 270, 290 (FIG. 2), 300 (FIG. 3), and instructions implementing the flowchart 400 (FIG. 4) may be associated with a computer 500 in the form of hardware, software, firmware, or a combination thereof. In the case of software, any one or more of 110, 120, 130, 140 (FIG. 1), 210, 220, 240, 260, 270, 290 (FIG. 2), 300 (FIG. 3), and instructions implementing the flowchart 400 (FIG. 4) may be associated with the applications 524 or the peripheral computer-readable media 502, among other things. Any one or more of 110, 120, 130, 140 (FIG. 1), 210, 220, 240, 260, 270, 290 (FIG. 2), 300 (FIG. 3), and instructions implementing the flowchart 400 (FIG. 4) may be associated with applications 524 for the same computer 500 or for different computers 500. Any one or more of 110, 120, 130, 140 (FIG. 1), 210, 220, 240, 260, 270, 290 (FIG. 2), 300 (FIG. 3), and instructions implementing the flowchart 400 (FIG. 4) may be associated with the same computer-readable media 502 or different computer-readable media 502. According to one embodiment, 110, 120, 130 (FIG. 1) are on separate computer-readable media 502 and are installed on one or more computers 500 as described herein. According to one embodiment, 210, 220, 240, 260, 270, 290 are on separate computer-readable media 502 that are used to install 210, 220, 240, 260, 270, 290 onto the server device 200A and the electronic device 200B as depicted in FIG. 2. The mappings 140 (FIG. 1), 230, 280 (FIG. 2) may be stored as data 528, among other things, that is used by the same computer 500 or different computers 500.

Various embodiments have been described in various combinations. However, any two or more embodiments may be combined. Further, any embodiment may be used separately from any other embodiments.

The foregoing description, for purposes of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of providing manageability to an electronic device 200B that supports location limited manageability functionality, the method comprising:
detecting 420 a request for a first function, which is associated with a first device management protocol;
accessing 430 a mapping 140 between a device location agnostic device management entity 110's functions, which are associated with a device location agnostic device management protocol that is used for communicating with a first set of electronic devices regardless of the location of the first set of electronic devices, and a device location limited device management entity 130 130's functions, which are associated with a device location limited device management protocol that is only capable of communicating with a second set of electronic devices when the second set of electronic devices are in a particular location;
translating 440, based on the mapping 140, the first function to a second function, which is associated with a device management protocol that is different from the first electronic device management protocol; and
providing 450 manageability to the electronic device 200B using the second function.

2. The method as recited in claim 1, wherein:
the detecting 420 of the request for the first function further comprises detecting the request for a device location limited device management entity 130's function, which is associated with device location limited device management protocol; and
the translating 440 based on the mapping 140 further comprises translating based on the mapping 140 of the first function to the second function, which is a device location agnostic device management entity 110's function and is associated with a device location agnostic protocol.

3. The method as recited in claim 1, wherein:
the detecting 420 of the request for the first function further comprises detecting request of a device location agnostic device management entity 110's function, which is associated with device location agnostic device management protocol; and
the translating 440 based on the mapping 140 further comprises translating based on the mapping 140 of the first function to the second function, which is a device location limited device management entity 130's function and is associated with a device location limited protocol.

4. The method as recited in claim 1, wherein the mapping 140 is a first mapping 280 and wherein the method further comprises:
accessing 430 a second mapping 230 between the device location agnostic device management entity 240's functions, which are associated with the device location agnostic device management protocol that is used for communicating with the first set of electronic devices regardless of where the first set of electronic devices are located, and the device location limited device management entity 210's functions, which are supported by the electronic device 200B and are associated with the device location limited device management protocol that cannot be used for communicating with the second set of electronic devices regardless of where the second set of electronic devices are located; and
translating 440 based on the second mapping 230 the second function to a third function, which is associated with a device management protocol that is different from the first device management protocol associated with the second function.

5. An apparatus for providing manageability to an electronic device 200B that supports location limited manageability functionality, the apparatus comprising:
a function-request-detector 310 configured for detecting 420 a request for a first function;
a mapping-between-device-location-agnostic-functions-and-device-location-limited-functions-accessor 320 configured for accessing 430 a mapping 140 between device location agnostic device management entity 110's functions, which are associated with a device location agnostic device management protocol that is used for communicating with a first set of electronic devices regardless of where the first set of electronic devices are located, and a device location limited device management entity 130's functions, which are associated with a device location limited device management protocol that restricts the location of a second set of electronic devices in order to communicate with the second set of electronic devices;
a translator-between-device-location-agnostic-functions-and-device-location-limited-functions 330 configured for translating 440 the first function to a second function based on the mapping 140; and
a manageability-provider 340 configured for providing 450 manageability to the electronic device 200B based on the second function.

6. The apparatus of claim 5, wherein the device location agnostic device management entity 110 is an Open Mobile Alliance Device Management (OMA-DM) capable entity.

7. The apparatus of claim 5, wherein the device location limited device management entity 130 is an entity selected from a group consisting of a Web Services Management (WSMAN) capable entity, a Simple Network Management Protocol (SNMP) capable entity, a Technical Requirement-069 (TR-069) capable entity, and a Technical Requirement-111 (TR-111) capable entity.

8. The apparatus of claim 5, wherein the electronic device 200B is a mobile device and the apparatus 300 provides manageability for the mobile device regardless of where the mobile device is located.

9. The apparatus of claim 5, wherein the electronic device 200B is behind a firewall and the apparatus 300 provides manageability for the electronic device 200B by communicating with an entity 110 that is not behind the firewall.

10. The apparatus of claim 5, wherein the electronic device 200B is behind a network address translation table (NAT) and the apparatus 300 provides manageability for the electronic device 200B by communicating with an entity 110 that is not behind the NAT.

11. A computer-usable medium having computer-readable program code stored thereon for causing a computer system to perform a method of providing manageability to an electronic device 200B that supports location limited manageability functionality, the method comprising:
detecting 420 a request for a first function, which is associated with a first device management protocol;
accessing 430 a mapping 140 between a device location agnostic device management entity 110's functions, which are associated with a device location agnostic device management protocol that is used for communicating with a first set of electronic devices regardless of where the first set of electronic devices are located, and a device location limited device management entity 130's functions, which are associated with a device location limited device management protocol that restricts the location of a second set of devices in order to communicate with the second set of devices;
translating 440 the first function to a second function, which is associated with a second device management protocol that is different from the first device management protocol, based on the mapping 140; and
providing 450 manageability to the electronic device 200B using the second function.

12. The computer usable medium of claim 11, wherein the computer-readable program code embodied therein causes a computer system to perform the method, and wherein:
the detecting 420 of the request for the first function further comprises detecting the request of a device location limited device management entity 130's function, which is associated with device location limited device management protocol; and
the translating 440 based on the mapping 140 further comprises translating based on the mapping 140 the first function to the second function, which is a device location agnostic device management entity 110's function and is associated with a device location agnostic protocol.

13. The computer usable medium of claim 11, wherein the computer-readable program code embodied therein causes a computer system to perform the method, and wherein:
the detecting 420 of the request for the function further comprises detecting the request for a device location agnostic device management entity 110's function, which is associated with device location agnostic device management protocol; and
the translating 440 based on the mapping 140 further comprises translating based on the mapping 140 the first function to the second function, which is a device location limited device management entity 130's function and is associated with a device location limited protocol.

14. The computer usable medium of claim 11, wherein the computer-readable program code embodied therein causes a computer system to perform the method, and wherein the mapping 140 is a first mapping 280 and wherein the method further comprises:
accessing 430 a second mapping 230 between the device location agnostic device management entity 240's functions, which are associated with the device location agnostic device management protocol that is used for communicating with the first set of electronic devices regardless of where the first set of electronic devices are located, and the device location limited device management entity 210's functions, which are supported by the electronic device and are associated with the device location limited device management protocol that cannot be used for communicating with the second set of electronic devices regardless of where the second set of electronic devices are located; and
translating 440 based on the second mapping 230 the second function to a third function, which is associated with a device management protocol that is different from the first device management protocol associated with the second function.

15. The computer usable medium of claim 11, wherein the computer-readable program code embodied therein causes a computer system to perform the method, and wherein the electronic device 200B is a mobile device and the method further comprises:
providing manageability to the mobile device regardless of where the mobile device is located.
